(19) United States
(12) Patent Application Publication
(10) Pub. No.: US 2023/0209111 A1
(43) Pub. Date: Jun. 29, 2023

(54) SUPPORTING CHANNEL CHANGE REQUESTS IN BROADCAST SWITCHED DIGITAL VIDEO (SDV)

(71) Applicant: ARRIS Enterprises LLC, Suwanee, GA (US)

(72) Inventors: Jason GUO, Shenzhen (CN); Chuankai KOU, Shenzhen (CN); Wenwu WEI, Shenzhen (CN)

(73) Assignee: ARRIS Enterprises LLC, Suwanee, GA (US)

(21) Appl. No.: 18/087,487

(22) Filed: Dec. 22, 2022

(30) Foreign Application Priority Data
Dec. 24, 2021 (CN) 202111596455.0

(51) Int. Cl. H04N 21/2387; H04N 21/234; H04N 21/438; H04N 21/472

(52) U.S. Cl. CPC H04N 21/2387; H04N 21/234; H04N 21/472; H04N 21/4383

(57) ABSTRACT

Systems and methods for changing broadcast channels using channel change requests to, and channel change responses from, an SDV server. In some embodiments, the channel change request is made after determining that broadcast tuning parameters are otherwise not available from memory and/or a broadcast system.

### CROSS REFERENCE TO RELATED APPLICATIONS

The present application claims priority to Chinese Patent Application No. 202111596455.0, filed Dec. 24, 2021, the content of which is incorporated herein by reference in its entirety.

### BACKGROUND

Cable TV (CATV) systems were initially deployed as video delivery systems. In its most basic form, the system received video signals at the cable head end, processed these signals for transmission, and broadcast them to homes via a tree and branch coaxial cable network. In order to deliver multiple TV channels concurrently, early CATV systems assigned 6 MHz blocks of frequency to each channel and Frequency Division Multiplexed (FDM) the channels onto the coaxial cable RF signals. Amplifiers were inserted along the path as required to boost the signal and splitters and taps were deployed to enable the signals to reach the individual homes. Thus, all homes received the same broadcast signals. As the reach of the systems increased, the signal distortion and operational cost associated with long chains of amplifiers became problematic and segments of the coaxial cable were replaced with fiber optic cables to create a Hybrid Fiber Coax (HFC) network to deliver the RF broadcast content to the coaxial neighborhood transmission network. Optical nodes in the network acted as optical to electrical converters to provide the fiber-to-coax interfaces.

As the cable network evolved, broadcast digital video signals were added to the multiplexed channels. The existing 6 MHz spacing for channels was retained but with the evolving technology, each 6 MHz block could now contain multiple programs. Up to this point, each home received the same set of signals broadcast from the head end so that the amount of spectrum required was purely a function of the total channel count in the program line-up.

The next major phase in CATV evolution was the addition of high-speed data service, which is an IP packet-based service, but appears on the HFC network as another 6 MHz channel block (or given data service growth, more likely as multiple 6 MHz blocks). These blocks use FDM to share the spectrum along with video services. Unlike broadcast video, each IP stream is unique. Thus, the amount of spectrum required for data services is a function of the number of data users and the amount of content they are downloading. With the rise of the Internet video, this spectrum is growing at 50% compound annual growth rate and putting significant pressure on the available bandwidth. Unlike broadcast video, data services require a two-way connection and therefore the cable plant had to provide a functional return path. Pressure on the available bandwidth has been further increased with the advent of narrowcast video services such as video-on-demand (VOD), which changes the broadcast video model as users can select an individual program to watch and use VCR-like controls to start, stop, and fast-forward. In this case, as with data service, each user requires an individual program stream.

Accordingly, HFC networks currently delivering a mix of broadcast video, narrowcast video, and high-speed data services. The original HFC network has been successfully updated to deliver new services, but the pressure of HD and narrowcast requires further change. The HFC network is naturally split into the serving areas served from the individual fiber nodes. The broadcast content needs to be delivered to all fiber nodes, but the narrowcast services need only be delivered to the fiber node serving the specific user. Thus, there is a need to deliver different service sets to each fiber node and also to reduce the number of subscribers served from each node (i.e., to subdivide existing serving areas and thus increase the amount of narrowcast bandwidth available per user).

One technique to address this need is Switched Digital Video (SDV). SDV systems send the digital video in a more efficient manner by bifurcating content into one set of popular channels that are broadcast to everyone, and another set of channels that are narrowcast on demand, where a QAM channel is assigned to a program or other content only when requested by a subscriber. This system frees up a substantia amount of bandwidth for services such as IP delivery because, at any given time, only a relatively small number of the total available channels are demanded by subscribers in a service group at any given time. Some variations on SDV systems allow individual channels or content to cross between the set of broadcast channels and the set of narrowcast channels based on the instantaneous popularity of the programs currently being broadcast. For example, an SDV system may be designed to broadcast the twenty most popular programs at any given time, where channels and/or programs may dynamically switch from being broadcast to being narrowcast, and vice versa as the number of viewers watching a channel/program changes.

With respect to the broadcast channels, subscribers must tune to the channels using their set-top box (STB) or other consumer premises equipment (CPE). For a CPE to receive one of the broadcast channels, the CPE uses broadcast tuning parameters to tune to the broadcast channel to receive content being offered on the channel. The CPE typically receives the broadcast tuning parameters via a broadcast control component, such as an electronic program guide (EPG) server or equivalent component. When there is a connection loss, such as might arise at the broadcast control component or elsewhere in the network, the subscriber device cannot retrieve the broadcast channel tuning parameters. Thus, the subscriber device may lose access to the broadcast channels.

What is desired then, are improved systems and methods for delivering broadcast content in a manner more resilient to connection losses or other issues that might interfere with a CPE’s ability to access broadcast tuning parameters.

### BRIEF DESCRIPTION OF THE DRAWINGS

FIG. 1 depicts a simplified system for receiving broadcast channels and switched digital video channels according to some embodiments.

FIG. 2 depicts a more detailed example of customer premises equipment according to some embodiments.

FIG. 3 depicts a simplified flowchart of a method for processing broadcast tuning parameters and switched digital video tuning parameters according to some embodiments.

FIG. 4 depicts a simplified flowchart of a method for using broadcast tuning parameters stored in a switched digital video cache when an issue occurs according to some embodiments.

FIG. 5 depicts an example of a switched digital video management message according to some embodiments.

FIG. 6 depicts a table that describes broadcast tuning parameters that are included in the switched digital video management message according to some embodiments.

FIG. 7 shows a simplified system for receiving broadcast channels and switched digital video channels according to an alternate embodiment.

FIG. 8 shows a simplified flowchart of a method for using the system of FIG. 7 in the alternate embodiment.

FIG. 9 illustrates an example of special purpose computer systems according to some embodiments.

### DETAILED DESCRIPTION

Described herein are techniques for a video delivery system. In the following description, for purposes of explanation, numerous examples and specific details are set forth in order to provide a thorough understanding of some embodiments. Some embodiments as defined by the claims may include some or all of the features in these examples alone or in combination with other features described below and may further include modifications and equivalents of the features and concepts described herein.

A customer premises equipment (CPE) device may have a broadcast client and a switched digital video (SDV) client. The broadcast client is configured to request and receive broadcast channels and the switched digital video client is configured to request and receive switched digital video. The broadcast client requests and receives a broadcast channel using broadcast channel tuning parameters and the switched digital video client requests and receives a switched digital video channel using switched digital video tuning parameters. Typically, the broadcast tuning parameters and the switched digital video tuning parameters are sent via different protocols, different systems, and at different frequency ranges.

In one preferred embodiment, when an issue occurs such that the CPE cannot receive the broadcast tuning parameters from the broadcast control component, the CPE may use broadcast tuning parameters that are sent via the switched digital video tuning parameters. For example, a switched digital video control component may add the broadcast tuning parameters to a message that is being used to send the switched digital video tuning parameters. Then, the CPE may retrieve the broadcast tuning parameters that are sent via switched digital video tuning parameters and use those broadcast tuning parameters to request a broadcast channel. Accordingly, the broadcast client can still receive broadcast channels when an issue occurs with the broadcast control component.

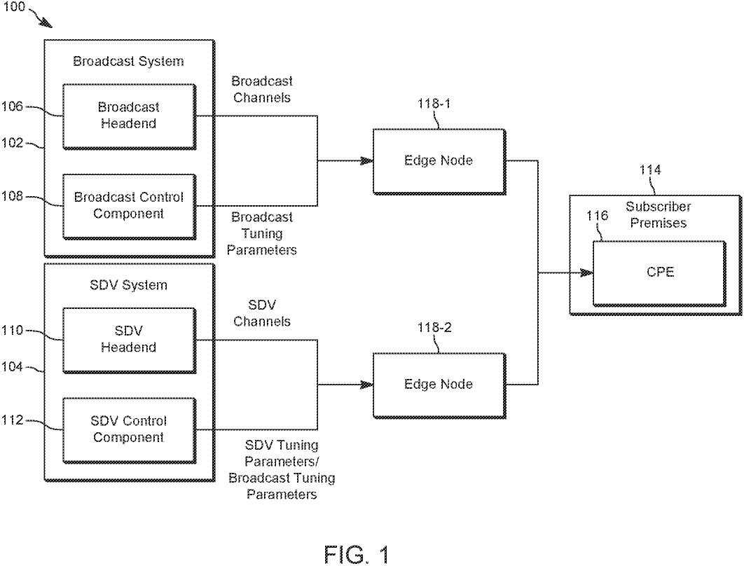

FIG. 1 depicts a simplified system 100 for receiving broadcast channels and switched digital video channels according to some embodiments. System 100 includes a broadcast system 102, a switched digital video (SDV) system 104, and subscriber premises 114. It is noted that broadcast system 102 and switched digital video system 104 may be connected to multiple subscriber premises 114 and CPEs 116.

CPE 116 may comprise one or more of a variety of subscriber devices, such as set-top boxes, cable modems, gateways, etc. Broadcast system 102 may broadcast channels of video to CPE 116 i.e., a broadcast headend 106 may send the broadcast channels to CPE 116. The channels may carry linear broadcasts of programs where each broadcast channel is available on the network for CPE 116 to tune to and request. However, switched digital video refers to an arrangement where broadcast channels are only switched onto a network when the broadcast channels are first requested by one or more subscribers, such as one or more CPE 116 in a service group, which is a group of subscribers that are served by a network segment. This allows a system operator to save bandwidth over the distribution network because a switched digital video channel is only available when requested by CPE 116. Unlike video-on-demand, which switches a single-cast interactive program to a specific subscriber, switched digital video switches broadcast streams making each stream available to one or more CPEs 116 that can join the broadcast stream, just as they would a normal broadcast channel. That is, once a switched digital video channel is sent to one CPE 116, other CPEs 116, such as a CPE associated with a same service group, can tune to the same broadcast stream offered by the switched digital video channel. Switched digital video allows a service provider to provide broadcast channels that are being watched by subscribers and those channels not requested by subscribers do not need to be broadcast, which saves bandwidth.

Broadcast system 102 and switched digital video system 104 will be described as separate systems, but may be implemented in the same computing device. A broadcast headend 106 may send broadcast channels to CPE 116 via an edge node 118-1. Additionally, a broadcast control component 108 may send broadcast tuning parameters via edge node 118-1 to CPE 116. The broadcast tuning parameters are parameters that CPE 116 uses to tune to a broadcast channel such that CPE 116 can receive a video from that broadcast channel. Broadcast control component 108 may be an electronic program guide (EPG) server or an equivalent component. In some embodiments, broadcast tuning parameters are sent via a first frequency spectrum or range. Broadcast channels are also sent via the first frequency spectrum.

Switched digital video system 104 includes a switched digital video (SDV) headend 110 that sends switched digital video channels to CPE 116 via edge node 118-2. Although different edge nodes 118 are described, it will be understood that the same edge node 118 may be used to send broadcast channels and switched digital video channels to CPE 116. However, different protocols may be used in addition to switched digital video is sent using a different frequency spectrum than the broadcast video. Broadcast system 102 and switched digital video system 104 may be separate systems, but may be implemented in the same computing device.

A switched digital video control component 112 sends switched digital video tuning parameters to CPE 116 via edge node 118-2. The switched digital video tuning parameters allow CPE 116 to request switched digital video channels. Switched digital video control component 112 may be a switched digital video provisioning server or equivalent component. SDV control component 112 sends the switched digital video tuning parameters via a second frequency spectrum or range that is different from the first frequency spectrum in which the broadcast tuning parameters are sent. Also, SDV control component 112 uses a different protocol to send the switched digital video tuning parameters compared to the protocol used to send the broadcast tuning parameters. For example, broadcast system 102 may use a first protocol to send the broadcast tuning parameters and switched digital video system 104 may use a second protocol to send the SDV tuning parameters. The switched digital video channels are also sent via the second frequency range.

As discussed above, CPE 116 may encounter an issue that affects the reception of the broadcast tuning parameters. To overcome the issue, switched digital video control component 112 may include broadcast tuning parameters with the switched digital video tuning parameters. For example, SDV control component 112 sends a management message that includes the switched digital video tuning parameters and also includes the broadcast tuning parameters in the management message. CPE 116 can then leverage the broadcast tuning parameters in the management message to request broadcast channels when an issue occurs with receiving broadcast tuning parameters from broadcast control component 108. As will be described in more detail below, the switched digital video tuning parameters may be provided in a switched digital video mini carousel message that is defined by a protocol. The mini carousel message may be sent between the switched digital video control component 112 and CPE 116.

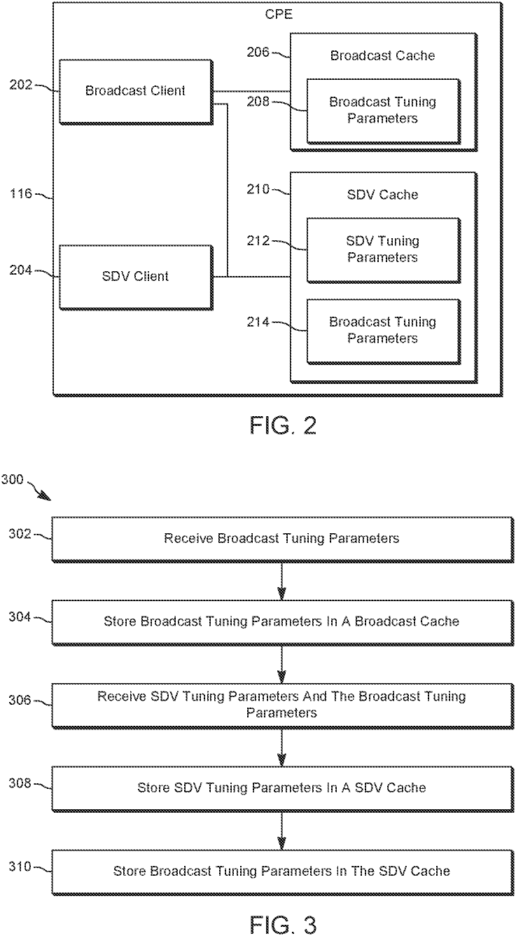

FIG. 2 depicts a more detailed example of CPE 116 according to some embodiments. CPE 116 includes a broadcast client 202 and a switched digital video client 204. Broadcast client 202 is configured to communicate with broadcast control component 108 to receive broadcast tuning parameters and switched digital video client 204 is configured to communicate with switched digital video control component 112 to receive switched digital video tuning parameters and broadcast tuning parameters. CPE 116 also includes a broadcast cache 206 and a switched digital video cache 210. Broadcast cache 206 is storage that stores recently received broadcast tuning parameters at 208 and switched digital video cache 210 is storage that stores switched digital video tuning parameters at 212 and broadcast tuning parameters at 214.

In some embodiments, broadcast client 202 receives the broadcast channels via a Data Over Cable Service Interface Specification (DOCSIS) protocol or any other appropriate protocol. Switched digital video client 204 receives the switched digital video channels using an Internet protocol (IP) or any other appropriate protocol e.g., an MPEG transport stream. Accordingly, CPE 116 may include both broadcast client 202 and a switched digital video client 204 because different protocols are used and separate systems are needed.

FIG. 3 depicts a simplified flowchart 300 of a method for processing broadcast tuning parameters and switched digital video tuning parameters according to some embodiments. At 302, broadcast client 202 receives broadcast tuning parameters in a first frequency spectrum, such as a frequency spectrum reserved for broadcast channel quadrature amplitude modulation (QAM) frequencies. For example, the broadcast tuning parameters may include a modulation mode, a carrier frequency, a program number, a service type, and a source identifier, which broadcast client 202 uses to tune to the broadcast channel to receive the video. At 304, broadcast client 202 may store broadcast tuning parameters at 208 in a broadcast cache 206. Then, broadcast client 202 can use the broadcast tuning parameters to tune to broadcast channels to receive video offered by a broadcast channel. The broadcast tuning parameters in broadcast cache 206 may remain valid for a period of time. However, at some point, the broadcast tuning parameters may change, such as the broadcast tuning parameters for a channel may change. Thus, if CPE 116 uses broadcast tuning parameters in broadcast cache 206 that may have changed, an error may result and CPE 116 may not receive the broadcast channel. That is, after an issue occurs with receiving the broadcast tuning parameters, the broadcast tuning parameters in broadcast cache 206 may allow broadcast client 202 to request broadcast channels for a time period, but then the broadcast tuning parameters may become invalid and need to be refreshed.

At 306, switched digital video client 204 receives switched digital video tuning parameters along with the broadcast tuning parameters in a second frequency spectrum. For example, switched digital video client 204 may receive a mini carousel message in a frequency spectrum reserved for switched digital video frequencies, such as switched digital video QAM frequencies. Switched digital video client 204 receives the mini carousel message and can extract the switched digital video tuning parameters. The mini carousel message includes a current list of switched digital video program channels with tuning parameters. Programs are included on the switched digital video channels and placed in the table by switched digital video control component 112. Some of the switched digital video parameters include a program number, a program map table, a program map table program clock reference, a program map table referenced to the mini carousel, and a mini carousel program ID. At 308, switched digital video client 204 extracts the switched digital video tuning parameters and can store the switched digital video parameters in a storage device, such as switched digital video cache 210. When a mini carousel message is received, switched digital video client 204 may check the version number of the program map that lists the programs offered by switched digital video head end 110 and determine if the program map has changed. If so, switched digital video client 204 updates the switched digital video tuning parameters at 212 in switched digital video cache 210.

Switched digital video client 204 also parses the management message to determine the broadcast tuning parameters. Switched digital video client 204 may distinguish the switched digital video parameters from the broadcast tuning parameters based on different methods. For example, a flag may indicate which parameters are broadcast tuning parameters. Then, at 310, switched digital video client 204 stores the broadcast tuning parameters in switched digital video cache 210. In some examples, both broadcast cache 206 and switched digital video cache 210 may be storing the same broadcast tuning parameters.

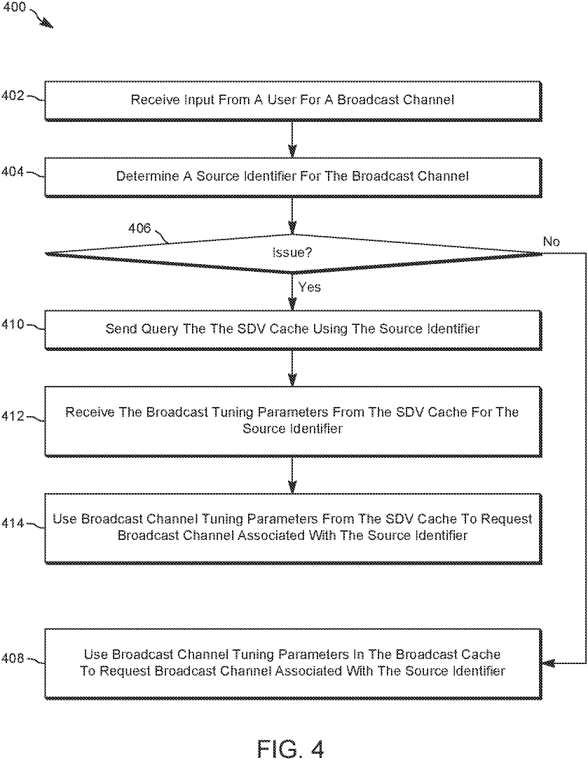

Once broadcast tuning parameters are stored in switched digital video cache 210, broadcast client 202 may access the broadcast channels using the broadcast tuning parameters stored in switched digital video cache 210 when an issue occurs. FIG. 4 depicts a simplified flowchart 400 of a method for using broadcast tuning parameters stored in switched digital video cache 210 when an issue occurs according to some embodiments. At 402, broadcast client 202 receives input from a user for a broadcast channel. For example, a user may select a channel that the user wants to view via a remote control. Then, at 404, broadcast client 202 determines a source identifier for the broadcast channel. The source identifier may uniquely identify the broadcast channel. For example, each broadcast channel may include a different source identifier.

At 406, broadcast client 202 determines if an issue has occurred with the broadcast tuning parameters. For example, an issue may occur that prevents CPE 116 from receiving broadcast tuning parameters from broadcast control component 108, such as broadcast control component 108 may have suffered an outage and cannot send the current broadcast tuning parameters or the network between broadcast control component 108 and edge node 118-1 may be down and the current broadcast tuning parameters that are sent are not being received. Further, there may be a problem with broadcast cache 206 in that the broadcast tuning parameters 208 in broadcast cache 206 may be out of date. For example, broadcast client 202 may use the broadcast tuning parameters in broadcast cache 206 to request the broadcast channel, but broadcast client 202 receives an error instead of receiving content for the broadcast channel.

If an issue is not occurring, however, at 408, broadcast client 202 uses broadcast channel tuning parameters in broadcast cache 206 to request the broadcast channel associated with the source identifier. For example, broadcast client 202 uses broadcast tuning parameters from broadcast headend 206 that include a modulation mode, a carrier frequency, a program number, a service type, and a source identifier to request and receive the video from the channel.

However, if broadcast client 202 determines an issue has occurred, at 410, broadcast client 202 sends a query to switched digital video cache 210 using the source identifier. For example, broadcast tuning parameters in switched digital video cache 210 may be stored based on source identifiers for the broadcast channels in the same way the broadcast tuning parameters are stored in broadcast cache 206.

At 412, broadcast client 202 may receive the broadcast tuning parameters from switched digital video cache 210 for the source identifier. For example, switched digital video client 204 may be receiving up-to-date broadcast tuning parameters in the management message along with the switched digital video tuning parameters. Switched digital video client 204 then updates the broadcast tuning parameters in switched digital video cache 210. Accordingly, the broadcast tuning parameters stored in switched digital video cache 210 may be more up-to-date than the broadcast tuning parameters stored in broadcast cache 206. Video for the broadcast channels may still be delivered by broadcast headend 106 and CPE 116 can be requested from edge node 118-1 even though an issue is occurring with the broadcast tuning parameters. Thus, at 414, broadcast client 202 uses the broadcast tuning parameters from switched digital video cache 210 to request the broadcast channel associated with the source identifier.

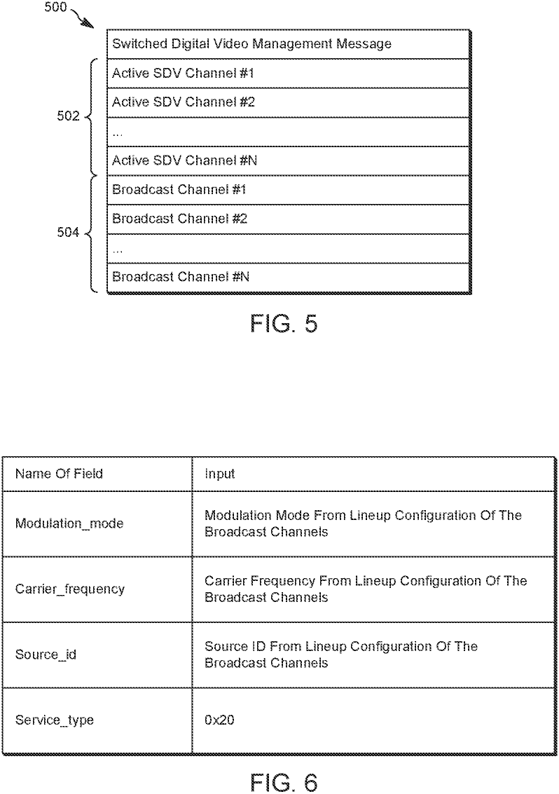

The switched digital video management message may be based on a protocol that defines how to send switched digital video tuning parameters. In some embodiments, a mini carousel syntax is defined by the protocol to send the switched digital video tuning parameters. In some embodiments, a Time Warner Cable Switched Digital Video Mini Carousel Message Interface Specification may be used. FIG. 5 depicts an example 500 of a switched digital video management message according to some embodiments. Switched digital video management message 500 includes a first section 502 that includes tuning parameters for active switched digital video channels #1 to #N. The active switched digital video channels may be the switched digital video channels that are currently being offered by switched digital video system 104. For example, not all switched digital video channels may be offered at once as described above.

At 504, switched digital video management message includes a second section that lists the broadcast tuning parameters for broadcast channels #1 to #N. These are the same broadcast tuning parameters that are sent using a message from broadcast control component 108.

FIG. 6 depicts a table that describes broadcast tuning parameters that are included in the switched digital video management message according to some embodiments. The name of the field in table includes the fields that may be included in the broadcast tuning parameters in the switched digital video management message. In some embodiments, the broadcast tuning parameters include a modulation_mode parameter, a carrier_frequency parameter, a source_ID parameter, and a service_type parameter. These are the broadcast tuning parameters that broadcast client 202 requires to request a broadcast channel. Although these parameters are discussed, other parameters may be included. Broadcast client 202 is configured to receive the modulation_mode parameter, carrier_frequency parameter, source_ID parameter, and service_type parameter and request the broadcast channel associated with the source ID by adding the information.

The modulation_mode parameter describes the modulation mode from the line-up configuration from the broadcast channels. The modulation mode may be a QAM64 modulation mode or a QAM256 modulation mode. The line-up configuration is the line-up of broadcast channels that are being offered by broadcast system 102. The carrier_frequency describes carrier frequency from the line-up configuration of the broadcast channel. The carrier frequency is a QAM carrier frequency and may be defined in Hertz (Hz). Different broadcast channels may use a modulation mode and be delivered on different frequencies. The source_ID parameter is the source identifier from the line-up configuration of the broadcast channels. The service_type parameter may indicate that these are static channels that do not change and is set to “0x20”.

Accordingly, when an issue occurs with broadcast tuning parameters, CPE 116 can use broadcast tuning parameters that are sent with switched digital video tuning parameters. This allows CPE 116 to continue to receive broadcast channels when broadcast channels are still being broadcast even though an issue is occurring with the broadcast tuning parameters from broadcast control component 108.

As noted earlier, in existing systems the CPE 116 is unable to access channels in a broadcast lineup whenever a service outage prevents a control component 108 from sending tuning parameters and/or the tuning parameters in the broadcast cache memory 206 is out of date. The embodiment previously described with respect to FIGS. 2 and 3 address this issue by duplicating the tuning parameters in cache memory 210 of the CPE 116 dedicated to the SDV system, which allows the cache memory 210 to be updated via the SDV data flow when the tuning parameters cannot be acquired in the broadcast data flow.

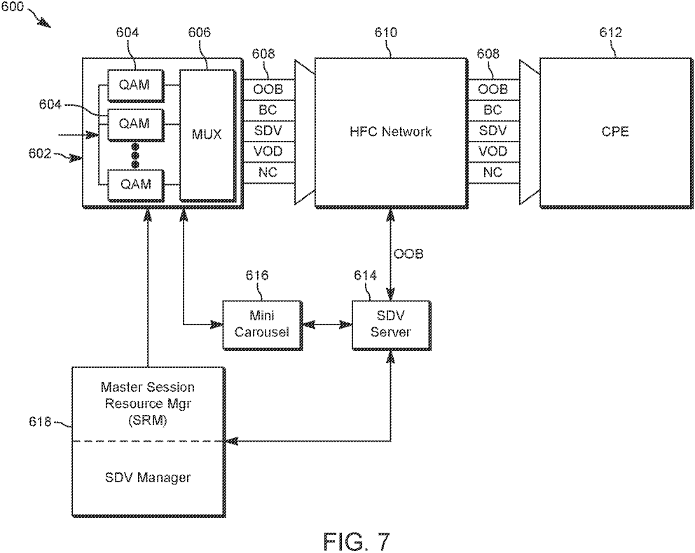

FIG. 7 shows an alternate embodiment that allows the CPE 116 to retain access to broadcast channels in the event that some network issue prevents access to broadcast tuning parameters from a broadcast head end 106. Specifically, FIG. 7 shows a system 600 having a head end 602 that includes a plurality of QAM modulators 604 that respectively modulate a variety of content onto a downstream signal 608 via multiplexer 606. The downstream content may include, for example, broadcast content, SDV content, VOD content and other narrowcast content, as well as an out-of-bandwidth (OOB) spectrum dedicated to control signals communicated between components of the network 600. Thus, those of ordinary skill in the art will recognize that the system 602 may preferably include for example, the broadcast system 102 and the SDV system 104 shown in FIG. 1.

The downstream signal 108 is received by HFC network 610, which in turn provides the downstream signal 608 to CPE 612, which may be a set top box or other subscriber device. The system 600 also preferably includes an SDV server 614, a mini-carousel 616, and a Master Session Resource Manager (SRM) 618, which in some embodiments may include an SDV manager. The SDV server 614 keeps track of customers’ channel change requests for SDV content and, as described below, may also optionally receive and provide channel change requests/responses to the CPE 612 for broadcast content in the event of a network issue that would otherwise prevent the CPE 612 from changing channels. The mini-carousel 616 maintains a current lineup of available SDV channels, as indicated earlier. The SRM 618 sets up and tears down active channels on the QAMs, and generates a list of a current service group’s active channels for inclusion in the mini-carousel that is continuously sent to the STB.

In the alternate embodiment depicted in FIG. 7, rather than internally storing broadcast tuning parameters in SDV cache memory, the CPE 612 may simply make a channel change request for the broadcast channel via the SDV server 614 and/or the SRM 618. Thus, the SRM 618 in a preferred embodiment allows a service provider to provide tuning parameters (frequency, program numbers, etc.) for broadcast channels to the lineup configuration of the SDV system. In this manner, the SDV server 614 may receive and respond to channel change requests from the CPE that include broadcast channels.

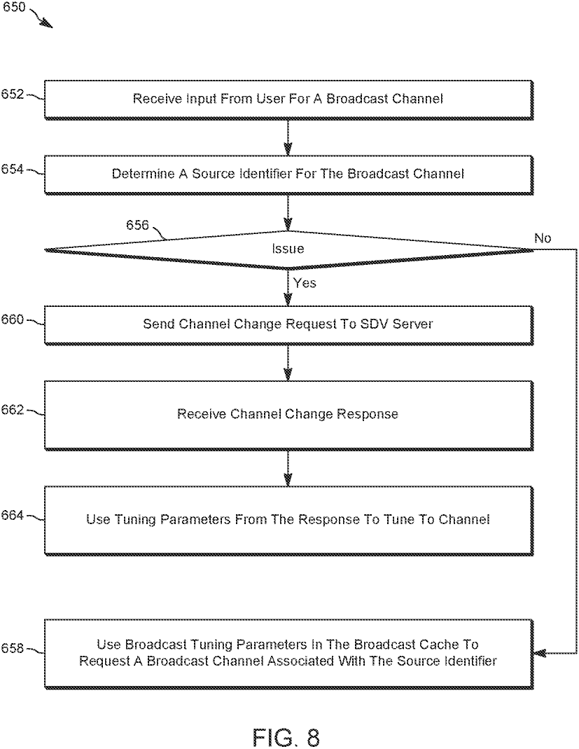

FIG. 8 shows an exemplary method by which the CPE 612 may male channel changes to or among broadcast channels. At 652, CPE 612 receives an input from a user for a broadcast channel. For example, a user may select a channel that the user wants to view via a remote control. Then, at step 654, CPE 612 determines a source identifier for the broadcast channel. The source identifier may uniquely identify the broadcast channel. For example, each broadcast channel may include a different source identifier.

At step 656, CPE 612 determines if an issue has occurred with the broadcast tuning parameters. For example, an issue may occur that prevents CPE 612 from receiving broadcast tuning parameters from broadcast control component 108. For example, broadcast control component 108 may have suffered an outage and cannot send the current broadcast tuning parameters or the network between broadcast control component 108 and edge node 118-1 may be down and the current broadcast tuning parameters that are sent are not being received. Further, there may be a problem with the broadcast cache in memory of CPE 612 in that the broadcast tuning parameters may be out of date. For example, the CPE 612 may use the broadcast tuning parameters in its broadcast cache to request the broadcast channel, but broadcast receives an error instead of receiving content for the broadcast channel.

If such an issue is not occurring, at step 858 CPE 612 uses broadcast channel tuning parameters in its broadcast cache to request the broadcast channel associated with the source identifier. For example, CPE 612 may use broadcast tuning parameters from a head end that include a modulation mode, a carrier frequency, a program number, a service type, and a source identifier to request and receive the video from the channel.

However, if CPE 612 determines an issue has occurred, at step 660, CPE 612 sends a channel change request to SDV server 614, which as indicated earlier is provisioned with the necessary tuning parameters to deliver a response. The appropriate response is sent, which is received at step 662. Then at step 664 the CPE 612 uses the received parameters to tune to the correct broadcast channel.

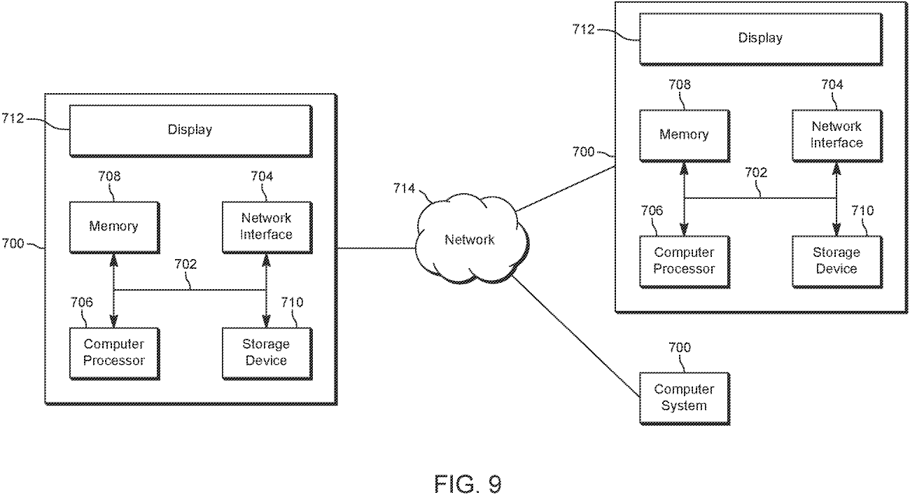

FIG. 9 illustrates an example of special purpose computer systems 700 according to some embodiments. Computer system 700 includes a bus 702, network interface 704, a computer processor 706, a memory 708, a storage device 710, and a display 712.

Bus 702 may be a communication mechanism for communicating information. Computer processor 706 may execute computer programs stored in memory 708 or storage device 710. Any suitable programming language can be used to implement the routines of some embodiments including C, C++, Java, assembly language, etc. Different programming techniques can be employed such as procedural or object oriented. The routines can execute on a single computer system 700 or multiple computer systems 700. Further, multiple computer processors 706 may be used.

Memory 708 may store instructions, such as source code or binary code, for performing the techniques described above. Memory 708 may also be used for storing variables or other intermediate information during execution of instructions to be executed by processor 706. Examples of memory 708 include random access memory (RAM), read only memory (ROM), or both.

Storage device 710 may also store instructions, such as source code or binary code, for performing the techniques described above. Storage device 710 may additionally store data used and manipulated by computer processor 706. For example, storage device 710 may be a database that is accessed by computer system 700. Other examples of storage device 710 include random access memory (RAM), read only memory (ROM), a hard drive, a magnetic disk, an optical disk, a CD-ROM, a DVD, a flash memory, a USB memory card, or any other medium from which a computer can read.

Memory 708 or storage device 710 may be an example of a non-transitory computer-readable storage medium for use by or in connection with computer system 700. The non-transitory computer-readable storage medium contains instructions for controlling a computer system 700 to be configured to perform functions described by some embodiments. The instructions, when executed by one or more computer processors 706, may be configured to perform that which is described in some embodiments.

Computer system 700 includes a display 712 for displaying information to a computer user. Display 712 may display a user interface used by a user to interact with computer system 700.

Computer system 700 also includes a network interface 704 to provide data communication connection over a network, such as a local area network (LAN) or wide area network (WAN). Wireless networks may also be used. In any such implementation, network interface 704 sends and receives electrical, electromagnetic, or optical signals that carry digital data streams representing various types of information.

Computer system 700 can send and receive information through network interface 704 across a network 714, which may be an Intranet or the Internet. Computer system 700 may interact with other computer systems 700 through network 714. In some examples, client-server communications occur through network 714. Also, implementations of some embodiments may be distributed across computer systems 700 through network 714.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured to perform that which is described in some embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. An apparatus comprising:
a processor and a communications interface capable of remote communication with Customer Premises Equipment (CPE);
a memory storing a plurality of tuning parameters comprising tuning parameters for broadcast channels and tuning parameters for Switched Digital Video (SDV) parameters; where
the processor is capable of receiving a channel change request from the CPE and responding to the channel change request, independent of whether the channel change request is for a broadcast channel or an SDV channel.

2. The apparatus of claim 1 comprising an SDV server.

3. The apparatus of claim 1 where the tuning parameters comprise at least one of a modulation mode, a carrier frequency, a program number, a service type, and a source identifier.

4. The apparatus of claim 1 communicatively coupled to a Session Resource Manager (SRM).

5. An apparatus comprising:
a processor and a communications interface capable of remote communication with an SDV server;
a memory storing a plurality of broadcast tuning parameters; where
the processor is configured to change channels from a first channel to a broadcast channel by alternatively using the broadcast tuning parameters in the memory or making a channel change request to the SDV server.

6. The apparatus of claim 5 where the processor is configured to make a channel change request to the SDV server after a request for broadcast tuning parameters from the memory fails.

7. The apparatus of claim 5 where the processor is configured to make a channel change request after determining that a network element is offline.

8. The apparatus of claim 1 comprising Customer Premises Equipment (CPE).

9. The apparatus of claim 1 where the tuning parameters comprise at least one of a modulation mode, a carrier frequency, a program number, a service type, and a source identifier.

10. A method implemented by Customer Premises Equipment (CPE) having a processor, the method comprising:
receiving an input comprising a request for a channel change to a broadcast channel;
selectively making a channel change request for the broadcast channel from an SDV server;
receiving a channel change response from the SDV server; and
using the channel change response to tune to the requested channel.

11. The method of claim 10 where the channel change response includes tuning parameters.

12. The method of claim 11 where the tuning parameters comprise at least one of a modulation mode, a carrier frequency, a program number, a service type, and a source identifier.

13. The method of claim 10 where the CPE selectively makes the channel change request to the SDV server after a request for broadcast tuning parameters from the memory fails.

14. The method of claim 10 where the CPE selectively makes the channel change request after determining that a network element is offline.
